(19) United States
(12) Patent Application Publication
(10) Pub. No.: US 2026/0170807 A1
(43) Pub. Date: Jun. 18, 2026

(54) ANIMAL BEHAVIOR PATTERN MINING SYSTEM, METHOD, COMPUTER DEVICE, AND STORAGE MEDIUM

(71) Applicant: SHENZHEN INSTITUTES OF ADVANCED TECHNOLOGY, SHENZHEN (CN)

(72) Inventors: MOXUAN LUO, SHENZHEN (CN); XING YANG, SHENZHEN (CN); QINGQING LIU, SHENZHEN (CN); LIPING WANG, SHENZHEN (CN)

(21) Appl. No.: 19/536,138

(22) Filed: Feb. 10, 2026

Related U.S. Application Data
(63) Continuation of application No. PCT/CN2023/112255, filed on Aug. 10, 2023.

(51) Int. Cl. G06V 10/764; G06V 10/82

(52) U.S. Cl. CPC G06V 10/764; G06V 10/82

(57) ABSTRACT

An animal behavior pattern mining system, a method, a computer device, and a storage medium. The system comprises a PC device and an experiment box body ; an infrared touch screen, a transparent box body, a camera, a thermal infrared probe and a brain endoscope are further separately provided in the experiment box body; the transparent box body is used for placing an experimental animal; the infrared touch screen, the camera and the thermal infrared probe are respectively used for acquiring trajectory data, video images, and body temperature data of the experimental animal; the brain endoscope, which may be a miniature integrated microscope or a fiber photometry system, is used for acquiring neuron signals of the experimental animal; the PC device is used for determining the behavior pattern category of the experimental animal by integrating the trajectory data, the video images, the body temperature data and the neuron signals.

### CROSS REFERENCE TO RELATED APPLICATIONS

The present application is a U.S. continuation of the PCT international phase application PCT/CN 2023/112255 filed on Aug. 10, 2023. The entire content of the above-identified application is incorporated herein by reference.

### TECHNICAL FIELD

The present application belongs to the technical field of biology, and particularly relates to an animal behavior pattern mining system, method, computer device, and storage medium.

### BACKGROUND

Animal behavior research is extremely important in the field of biology. By observing and recording animal behavior, studies can be conducted on the internal states of animals, such as psychology, neuroscience, and pharmacology of animals. When observing and recording animal behavior, certain methods and tools are required. In the prior art, the mainstream method for recording animal behavior is video recording via cameras. For example, the patent document CN202111628940.1 introduces a small animal behavior recording device with precise visual stimulation, which uses an overhead camera module to perform two-dimensional top-down image recording for animal behavior below. Another patent document CN201611174778.X describes a system for synchronously recording animal neuronal signals and behavior, which primarily uses a CCD (charge-coupled device) camera to record video images of experimental animals when they exhibit corresponding behaviors and determines whether corresponding signals are generated in brain regions of the experimental subjects based on the video images.

In summary, the animal behavior recording methods in the prior art remain merely to two-dimensional video recording. The captured video images are overly simplistic and can be affected by factors such as lighting, noise, and camera shake, which generates certain adverse effect on the final video image quality. Furthermore, they lack the integration of multimodal signals and the support of advanced algorithms. Additionally, the different actions recorded in two-dimensional videos are not independent and isolated from each other; they possess certain patterns and regularities. Sole reliance on two-dimensional video recording combined with subjective human judgment is prone to overlooking various details and lacks the ability for objective, comprehensive analysis at a macro level, thereby compromising the accuracy of animal behavior pattern identification.

### SUMMARY OF THE DISCLOSURE

The present application provides an animal behavior pattern mining system, method, computer device, and storage medium, aimed at addressing, at least to some extent, one of the aforementioned technical problems in the prior art.

In order to solve the aforementioned problems, the present application provides the following technical solutions.

An animal behavior pattern mining system comprises a PC device and an experiment box body, the PC device is located out of the experiment box body; the experiment box body is further provided therein with an infrared touch screen, a transparent box body, a camera, a thermal infrared probe, and a brain endoscope respectively; the infrared touch screen is arranged at a bottom of the experiment box body, the transparent box body is arranged above the infrared touch screen, the camera and the thermal infrared probe are respectively fixed on the transparent box body, and the infrared touch screen, the camera, the thermal infrared probe, and the brain endoscope are respectively connected to the PC device; the transparent box body is configured to place an experimental animal, the infrared touch screen, the camera, and the thermal infrared probe are respectively configured to acquire trajectory data, video images, and body temperature data of the experimental animal, the brain endoscope is configured to acquire neuron signals of the experimental animal; the PC device is configured to acquire a behavior pattern category of the experimental animal by combining the trajectory data, the video images, the body temperature data, and the neuron signals.

The technical solutions adopted by embodiments of the present application further comprise that: the experimental box body is a square structure with an aluminum alloy frame; surfaces of six faces of the experimental box body are covered with opaque acrylic panels, and sound-absorbing panels are attached to the inner side of each of the six faces; one side of the experimental box body is a detachable structure configured to place experimental animals therein during experiments.

The technical solutions adopted by embodiments of the present application further comprise that: the experimental box body further comprises a development board, a sound wave generator, and a display therein; the development board is arranged on an inner upper surface of the experimental box body, the sound wave generator and the display are respectively attached to an inner upper part of the experimental box body and are sequentially connected to the development board and the PC device via wires; the PC device is configured to control the development board to generate stimulation signals and thereby cause the sound wave generator and display connected therewith to produce auditory and visual stimuli respectively.

The technical solutions adopted by embodiments of the present application further comprise that: the experimental box body further comprises a data acquisition card therein, the infrared touch screen, the camera, the thermal infrared probe, and the brain endoscope are respectively connected to the data acquisition card, and the data acquisition card is connected to the PC device; the data acquisition card is configured to synchronize and package the trajectory data, video images, body temperature data, and neuronal signals and then transmit packaged data to the PC device.

The technical solutions adopted by embodiments of the present application further comprise that: the PC device comprises a deep convolutional network and a clustering mining module, and that the PC device is configured to acquire a behavior pattern category of the experimental animal by combining the trajectory data, the video images, the body temperature data, and the neuron signals is specifically as follows:
using the deep convolutional network to automatically identify an action category of the experimental animal in each frame of the video images, correcting the action category using the trajectory data, the body temperature data, and neuronal signals, and then outputting an action category sequence for the video images;
using the clustering mining module to perform clustering on the action category sequence in combination with the trajectory data, body temperature data, and neuronal signals, and map the clustered action category sequence to time series of the video images, thereby obtaining a behavioral pattern category sequence for the experimental animal.

The technical solutions adopted by embodiments of the present application further comprise that: the using the deep convolutional network to automatically identify an action category of the experimental animal in each frame of the video images is specifically as follows:
extracting all frame images from the video images, and randomly selecting a set number of frame images as a dataset requiring manual labeling;
organizing frame images of various categories from the dataset for manual labeling, and inputting the manually labeled training set images into the deep convolutional network for training, wherein ResNet50 is selected as a backbone network for the deep convolutional network;
inputting all frame images of the video images into the trained deep convolutional network, and using the deep convolutional network to automatically identify an action category of the experimental animal in each frame image;
training a fully connected layer of the deep convolutional network using the trajectory data, body temperature data, and neuronal signals, and outputting the action category sequence of the video images after correcting the action category of the experimental animal in each frame image.

The technical solutions adopted by embodiments of the present application further comprise that: the clustering mining module comprises a synchronization program, a clustering program, and a visualization program; the using the clustering mining module to perform clustering on the action category sequence in combination with the trajectory data, body temperature data, and neuronal signals is specifically as follows:
using the synchronization program to retrieve the packaged data and synchronize all packaged data onto a single timeline based on start and end times, time-stamping signals, and wavelet transform detection of the packaged data, and outputting a multi-dimensional array including time;
inputting the action category sequence and the multi-dimensional array into the clustering program for automatic clustering; wherein the clustering program uses differences in correlations between different-dimensional arrays of different action categories as distinction, identifies closely related action categories of the same type from the multi-dimensional array to generate behavioral pattern categories, and maps the behavioral pattern categories to the time series of the video images, thereby obtaining a behavioral pattern category sequence;
using the visualization program to convert the behavioral pattern category sequence into a subtitle file, and displaying the subtitle file in the video images.

Another technical solution adopt by the embodiments of the present application is an animal behavior pattern mining method, comprising:
using an infrared touch screen, a camera, a thermal infrared probe, and a brain endoscope to collect trajectory data, video images, body temperature data, and neuronal signals of an experimental animal respectively ;.
uploading the trajectory data, the video images, the body temperature data, and the neuronal signals to a PC device;
using the PC device to acquire a behavioral pattern category of the experimental animal by combining the trajectory data, the video images, the body temperature data, and the neuronal signals.

Another technical solution adopted by the embodiments of the present application is a computer device, the computer device comprises a processor and a memory coupled to the processor, wherein
the memory stores program instructions for implementing the animal behavior pattern mining method;
the processor is configured to execute the program instructions stored in the memory to control the animal behavior pattern mining method.

Another technical solution adopted by the embodiments of the present application is a storage medium storing processor-executable program instructions, wherein the program instructions are configured to execute the animal behavior pattern mining method.

Compared with the prior art, the embodiments of the present application generate advantageous effect in that: the animal behavior pattern mining system, method, computer device, and storage medium according to the embodiments of the present application utilize various electronic components to achieve synchronous recording of multimodal data such as video images, infrared temperature, real-time position, and neuronal signals. This enables comprehensive, three-dimensional capture of the behavioral states of experimental animals and avoids the impact of factors such as lighting, noise, and camera shake on the video images. Furthermore, a deep convolutional network is employed to automatically identify the action categories of the experimental animals in each frame of the video images. By combining these action categories with trajectory data, body temperature data, and neuronal signals, the behavioral pattern categories of the experimental animals are predicted. This approach fully leverages the patterns and regularities among different actions within the video images, thereby facilitating improved accuracy in the identification of animal behavior patterns.

### BRIEF DESCRIPTION OF THE DRAWINGS

FIG. 1 is a structural schematic diagram of an animal behavior pattern mining system according to an embodiment of the present application.

FIG. 2 is a working flowchart of a deep convolutional network according to an embodiment of the present application.

FIG. 3 is a working flowchart of a clustering mining module according to an embodiment of the present application.

FIG. 4 is a flowchart of an animal behavior pattern mining method according to an embodiment of the present application.

FIG. 5 is a structural schematic diagram of a computer device according to an embodiment of the present application.

FIG. 6 is a structural schematic diagram of a storage medium according to an embodiment of the present application.

### DETAILED DESCRIPTION

The technical solutions in the embodiments of the present application will be clearly and completely described below with reference to the accompanying drawings in the embodiments of the present application. It is obvious that the described embodiments are only some of the embodiments of the present application, rather than all of them. Based on the embodiments of the present application, all other embodiments obtained by a person of ordinary skill in the art without creative efforts shall fall within the protection scope of the present application.

The terms “first”, “second”, “third, and the like in the present application are used for descriptive purposes only and are not to be construed as indicating or implying relative importance or implicitly specifying the quantity of the indicated technical features. Thus, features defined with “first”, “second”, “third”, and the like may explicitly or implicitly include at least one such feature. In the description of the present application, the meaning of “a plurality of” is at least two, such as two, three, etc., unless otherwise explicitly and specifically defined. All directional indications (such as up, down, left, right, front, back, . . . ) in the embodiments of the present application are only used to explain the relative positional relationships, movement situations, etc., among various components in a certain specific posture (as shown in the accompanying drawings). If the specific posture changes, these directional indications shall change accordingly. Furthermore, the terms “include” and “have”, as well as any variations thereof, are intended to cover non-exclusive inclusion. For example, a process, method, system, product, or device comprising a series of steps or units is not limited to the listed steps or units, but may optionally also include steps or units not listed, or may optionally further include other inherent steps or units for such processes, methods, products, or devices.

Mentioning “embodiments” herein means that specific features, structures, or characteristics described in connection with the embodiments may be included in at least one embodiment of the present application. The appearance of this phrase at various places in the specification does not necessarily refer to the same embodiment, nor is it an independent or alternative embodiment mutually exclusive to other embodiments. Those skilled in the art can explicitly and implicitly understand that the embodiments described herein may be combined with other embodiments.

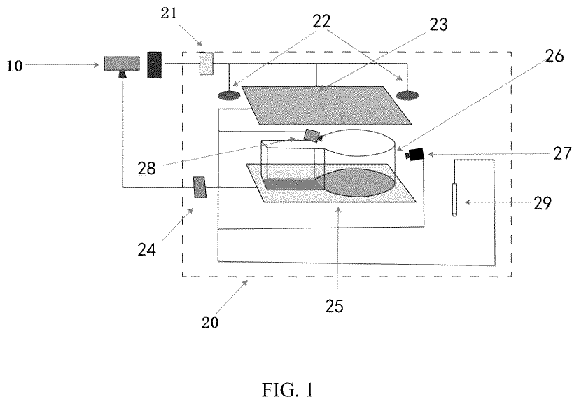

Referring to FIG. 1, which is a structural schematic diagram of an animal behavior pattern mining system according to an embodiment of the present application. The animal behavior pattern mining system according to the embodiment of the present application includes a PC device 10 and an experiment box body 20, the PC device 10 is located out of the experiment box body 20. The experimental box body 20 is a square structure with an aluminum alloy frame; surfaces of six faces of the experimental box body 20 are covered with opaque acrylic panels, and sound-absorbing panels (not shown) are attached to the inner side of each of the six faces. One side of the experimental box body 20 is a detachable structure configured to place experimental animals therein during experiments. The experiment box body 20 further includes a development board 21, a sound wave generator 22, a display 23, a data acquisition card 24, an infrared touch screen 25, a transparent box body 26, a camera 27, a thermal infrared probe 28, and a brain endoscope 29 therein. Among them, the development board 21 is arranged on an inner upper surface of the experimental box body 20, the sound wave generator 22 and the display 23 are respectively attached to an inner upper part of the experimental box body 20 and are sequentially connected to the development board 21 and the PC device 10 via wires. The data acquisition card 24 is attached to an inner left surface of the experimental box body 20 and is connected to the PC device 10 via wires. The infrared touch screen 25 is arranged at a bottom of the experimental box body 20 and is connected to the data acquisition card 24 via wires. The transparent box body 26 is a device formed by splicing three transparent planar surfaces and one transparent curved surface, it is arranged above the infrared touch screen 25. The camera 27 and the thermal infrared probe 28 are respectively fixed to two transparent surfaces of the transparent box body 26 by fixing assemblies (not shown). The focal points of the camera 27 and of the thermal infrared probe 28 are respectively aligned with a center position of the transparent box body 26, and they are connected to the data acquisition card 24 via wires. The brain endoscope 29 may be a miniature integrated microscope or a fiber photometry system, and is placed inside the experimental box body 20 and is connected to the data acquisition card 24 via wires.

Specifically, the development board 21 is an Arduino development board. The PC device 10 is configured to control the development board 21 to generate specific signals, causing the sound wave generator 22 and the display 23 to produce auditory and visual stimuli, respectively. The programs for the sound wave generator 22 and the display 23 can be custom-designed using languages such as Python or C++ according to experimental needs. The above control operations can be set via computer programming using the PC device 10. The frame rate of the infrared touch screen 25 is set to 120 fps for recording trajectory data of experimental animals. The camera 27 is a USB wide-angle camera with a resolution of 1960*1080 and a frame rate of 60 fps, and is used to capture direct behavioral actions of experimental animals. The frame rate of the thermal infrared probe 28 is 60 fps; during operation, background temperature noise is removed, and it is used to record body temperature data of experimental animals in real time. The fixing assemblies for securing the camera 27 and the thermal infrared probe 28 include, but are not limited to, screws. The brain endoscope 29 is used to observe neuronal activity in experimental animals through optical signal detection and to collect neuronal signals corresponding to the experimental animals' neuronal activity. It can be understood that the product types and parameters of the aforementioned development board 21, sound wave generator 22, display 23, data acquisition card 24, infrared touch screen 25, camera 27, thermal infrared probe 28, and brain endoscope 29 can be selected according to actual application scenarios.

In embodiments of the present application, the PC device 10 includes, but is not limited to, electronic devices such as desktop computers, all-in-one computers, laptop computers, or tablet computers. A microcontroller may also be used as an alternative to the PC device. The six surfaces of the experimental box body 20 are covered with opaque acrylic panels, and sound-absorbing panels are attached to their inner sides. In this way, on the premise of ensuring the airtightness of the experimental box body, external noise and other interfering factors are effectively isolated, thereby preventing disturbances from other environmental factors during experiments. It can be understood that the experimental box body 20 may also be equipped with or replaced by other special materials for use in other specific environments, such as high/low temperatures.

Furthermore, the implementation process of the animal behavior pattern mining system according to the embodiment of the present application is as follows. Before an experiment begins, the PC device 10 is activated, and it drives the sound wave generator 22, the display 23, the infrared touch screen 25, the camera 27, the thermal infrared probe 28, and the brain endoscope 29 accordingly. At the start of the experiment, a panel on one side of the experimental box body 20 is opened. The brain endoscope 29 placed inside the experimental box body 20 is inserted into a cranial opening of an experimental animal. The experimental animal is then placed into the transparent box body 26 within the experimental box body 20, wherein the experimental animal has been injected with an experimental virus to label its neurons with specific proteins. Subsequently, the various electronic devices within the experimental box body 20 are debugged and tested. Under the program-driven control of the PC device 10, it is verified whether the display 23 shows images, whether the sound wave generator 22 emits sound, whether the camera 27 and the thermal infrared probe 28 capture the scene inside the transparent box body 26, whether the infrared touch screen 25 collects the position of the experimental animal, and whether the brain endoscope 29 collects neuronal signals from the experimental animal, etc. After the testing is completed, the panel on the side of the experimental box body 20 is closed, and the experiment commences. After the experiment begins, the PC device 10 controls the development board 21 to generate specific stimulation signals, causing the sound wave generator 22 and the display 23 connected therewith to produce auditory and visual stimuli, respectively. Simultaneously, the infrared touch screen 25 uses infrared reflection to track trajectory data of the experimental animal, the camera 27 captures video images of the experimental animal in real time, the thermal infrared probe 28 collects body temperature data of the experimental animal, and the brain endoscope 29 gathers neuronal signals from the experimental animal. Subsequently, the obtained multimodal data, including the trajectory data, the video images, the body temperature data, and the neuronal signals, is uploaded in real time to the data acquisition card 24 for synchronization and packaging. The data acquisition card 24 then transmits the packaged data to the PC device 10. The PC device 10 uses a deep convolutional network trained on manually labeled images to automatically identify the action category of the experimental animal in each frame of the video images. After correcting the action categories using the trajectory data, the body temperature data, and the neuronal signals, it outputs an action category sequence for the video images. Next, it uses a clustering mining module to perform clustering on the action category sequence in combination with the trajectory data, the body temperature data, and the neuronal signals. The clustered action category sequence is then mapped to the time series of the video images, thereby obtaining a behavioral pattern category sequence for the experimental animal. It can be understood that the experimental animal includes, but is not limited to, small experimental animals such as rats, mice, and guinea pigs, or larger experimental animals such as cats, dogs, and monkeys. The sizes of the experimental box body 20 and the transparent box body 26 can be specifically adjusted according to the size of the experimental animal.

Specifically, the main body of the deep convolutional network is composed of a convolutional neural network. After manually labeled images are input therein and training is performed, it can automatically identify the action category corresponding to each frame of image in video images captured by a small camera. To deploy the deep convolutional network and embed it into the system, the embodiments of the present application have optimized and improved conventional deep neural network operating infrastructure. The related programs are written in Python language and run on a workstation computer equipped with a GeForce RTX 3050. The video images are first preprocessed and split into images of different frame counts. A certain number of images are then randomly selected as a dataset requiring labeling. This dataset is input into a ResNet50 network for training. After training is completed, the captured video images are input into the ResNet network, and predicted values are output as an output result for the experimental animal's action categories. It can be understood that the ResNet50 network can also be replaced with other types of deep convolutional networks, such as ResNet101.

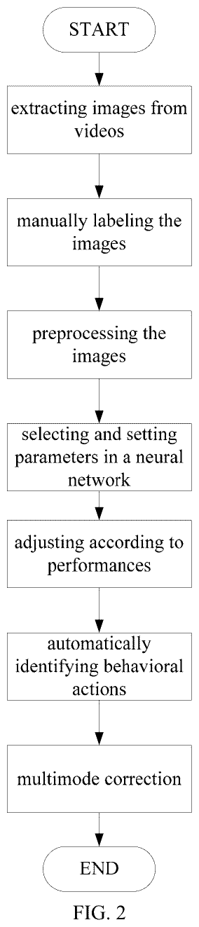

Furthermore, referring to FIG. 2, which is a working flowchart of a deep convolutional network according to an embodiment of the present application. An action category identification process of the deep convolutional network specifically includes the follows.

The first step, all frame images are extracted from the video images, and a certain number of frame images are randomly selected as a dataset requiring manual labeling.

The second step, through the program's GUI (Graphical User Interface), frame images of various categories are organized from the dataset for manual labeling, and the manually labeled training set images are input into the deep convolutional network for training. Among them, it is also necessary to increase the sample amount of the frame images through data augmentation preprocessing methods, so as to ensure that the quantity of the labeled images for each category can meet the network training requirements. The deep convolutional network selects ResNet50 as the backbone network, sets parameters such as learning rate, training sample amount for every time, update function, and so on, and then initiates the training mode. During the training process, the loss function and accuracy change curves are displayed on a screen and recorded in real time in a document. After training ends, the previous parameters are adjusted based on its performance and the process is iterated again.

The third step, the trained deep convolutional network is adjusted into a test mode, all frame images of the video images are input into the deep convolutional network, and an action category of the experimental animal in each frame image is automatically identified through the deep convolutional network.

The fourth step, a fully connected layer of the deep convolutional network is trained using the trajectory data, body temperature data, and neuronal signals in the packaged data, and the action category sequence of the video images is output after correcting the action category of the experimental animal.

Furthermore, the clustering mining module includes a synchronization program, a clustering program, and a visualization program. The synchronization program is used to normalize and synchronize the packaged data from the data acquisition card 24, and output a multi-dimensional array that includes time and various recorded data sequences. The clustering program is adapted from a Toeplitz inverse covariance-based clustering method (abbreviated as TICC). Its core lies in deep learning and Markov processes, and it is used to automatically identify closely related action categories of the same type from the multi-dimensional array by using differences in correlations between different-dimensional arrays of different action categories as distinction, thereby generating behavioral pattern categories. Finally, it outputs a sequence labeled with different behavioral pattern categories. The visualization program is used to display the behavioral pattern category sequence in the form of subtitles overlaid on the time series of the original video images, facilitating researchers in determining whether the behavioral pattern recognition is accurate and adjusting the parameter settings of the clustering program accordingly. It can be understood that the TICC clustering algorithm can also be replaced by other multi-dimensional data clustering algorithms such as K-means.

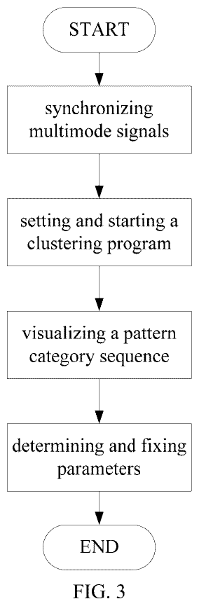

Specifically, as shown in FIG. 3, which is a working flowchart of a clustering mining module according to an embodiment of the present application. A matching process for the clustering mining module to match an output result of the deep convolutional network to the corresponding time series of the video images specifically includes the following.

The first step, the synchronization program is used to retrieve the packaged data uploaded by the data acquisition card, synchronize all packaged data onto a single timeline based on start and end times, time-stamping signals, and wavelet transform detection of the packaged data, and a multi-dimensional array including multimodal data such as time is output.

The second step, the action categories output by the deep convolutional network are input into the clustering program together with the multi-dimensional array. After setting parameters for the clustering program such as the number of clusters, convergence criteria, interval duration, and so on, the clustering program is executed. It then automatically performs clustering to generate behavioral pattern categories and maps these behavioral pattern categories to the time series of the video images, thereby obtaining a behavioral pattern category sequence.

The third step, the visualization program is used to convert the behavioral pattern category sequence into a subtitle file, and displaying the subtitle file in the video images. Researchers use the video images along with the subtitle file to judge whether the behavioral pattern recognition is correct. After adjusting the relevant parameters of the clustering program, the process is iterated again until the behavioral pattern categories align with the researchers' empirical judgment. Then the parameters of the clustering program are fixed for subsequent data clustering use.

Based on the above, the animal behavior pattern mining system according to the embodiments of the present application utilize various electronic components to achieve synchronous recording of multimodal data such as video images, infrared temperature, real-time position, and neuronal signals. This enables comprehensive, three-dimensional capture of the behavioral states of experimental animals and avoids the impact of factors such as lighting, noise, and camera shake on the video images. Furthermore, a deep convolutional network is employed to automatically identify the action categories of the experimental animals in each frame of the video images. By combining these action categories with trajectory data, body temperature data, and neuronal signals, the behavioral pattern categories of the experimental animals are predicted. This approach fully leverages the patterns and regularities among different actions within the video images, thereby facilitating improved accuracy in the identification of animal behavior patterns. The present application is conveniently configured, imposes no restrictions on usage time, and can be widely applied to experimental animals of various species and sizes.

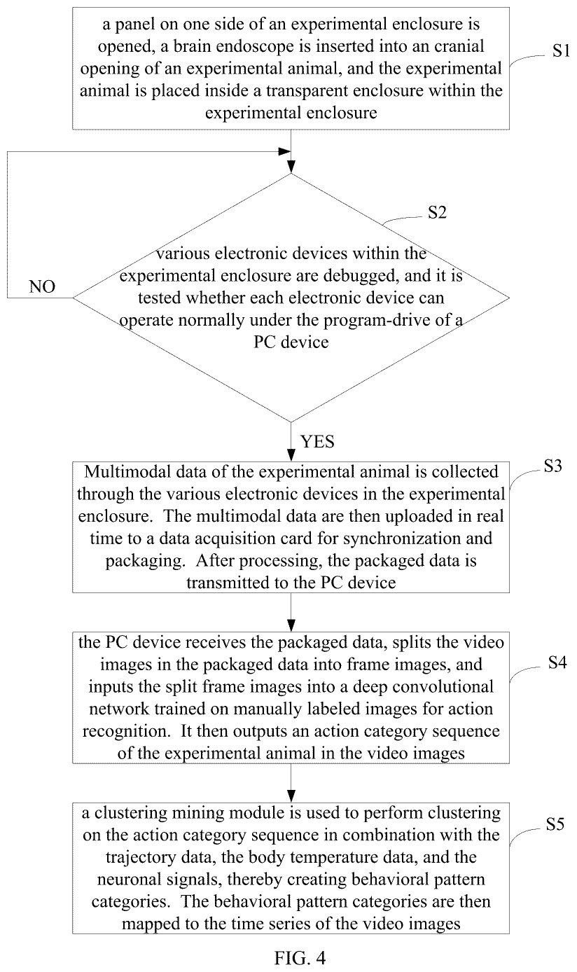

Referring to FIG. 4, which is a flowchart of an animal behavior pattern mining method according to an embodiment of the present application. The animal behavior pattern mining method according to the embodiment of the present application includes the following steps.
S1: a panel on one side of an experimental box body is opened, a brain endoscope is inserted into an cranial opening of an experimental animal, and the experimental animal is placed inside a transparent box body within the experimental box body.
S2: various electronic devices within the experimental box body are debugged, and it is tested whether each electronic device can operate normally under the program-drive of a PC device. If yes, S3 is executed; otherwise, S2 is continuously executed.

In this step, the electronic devices in the experimental box body include a sound wave generator, a display, an infrared touch screen, a camera, a thermal infrared probe, and the brain endoscope. The sound wave generator and the display are respectively used to produce auditory and visual stimuli; the camera is used to capture direct behavioral actions of the experimental animal; the infrared touch screen is used to record a behavioral trajectory of the experimental animal; the thermal infrared probe is used to record body temperature data of the experimental animal in real time; and the brain endoscope is used to detect neuronal activity in the experimental animal through optical signals and collect corresponding neuronal signals. Testing whether each electronic device can operate normally under the program-driven of the PC device specifically includes: testing whether the display shows images, whether the sound wave generator emits sound, whether the camera and thermal infrared probe capture scenes inside the transparent box body, whether the infrared touch screen collects the position of the experimental animal, and whether the brain endoscope collects neuronal signals from the experimental animal, etc.
S3: Multimodal data of the experimental animal is collected through the various electronic devices in the experimental box body. The multimodal data are then uploaded in real time to a data acquisition card for synchronization and packaging. After processing, the packaged data is transmitted to the PC device.

In this step, the multimodal data include trajectory data, video images, body temperature data, neuronal signals, etc. The data acquisition card is attached to the inner side of the experimental box body and connected to the PC device via wires. It is used to collect the multimodal data gathered by various electronic devices within the experimental box body and transmits the multimodal data to the PC device for behavioral pattern recognition of the experimental animal.
S4, the PC device receives the packaged data, splits the video images in the packaged data into frame images, and inputs the split frame images into a deep convolutional network trained on manually labeled images for action recognition. It then outputs an action category sequence of the experimental animal in the video images.

In this step, the main body of the deep convolutional network is composed of a convolutional neural network. After manually labeled images are input therein and training is performed, it can automatically identify the action category corresponding to each frame of image in video images captured by a camera. The video images are first preprocessed and split into different frame images. Some of the frame images are then randomly selected as a dataset requiring labeling. This dataset is input into a deep convolutional network for training. After training is completed, the captured video images are input into the deep convolutional network, and predicted values are output as an output result for the experimental animal's action categories. In this embodiment of the present application, the deep convolutional network selects a ResNet50 network as its backbone network. It can be understood that the ResNet50 network can also be replaced with other types of deep convolutional networks, such as ResNet101.

In particular, the behavioral pattern category recognition process of the deep convolutional network specifically includes the following.

The first step, all frame images are extracted from the video images, and a certain number of frame images are randomly selected as a dataset requiring manual labeling.

The second step, through the program's GUI, images of various categories are organized from the dataset for manual labeling, and the manually labeled training set images are input into the deep convolutional network for training. Among them, it is also necessary to increase the sample amount of the images through data augmentation preprocessing methods, so as to ensure that the number of labeled images for each category exceeds one thousand. Parameters such as network learning rate, training sample amount for every time, update function, and the like are set, and then initiates the training mode. During the training process, the loss function and accuracy change curves are displayed on a screen and recorded in real time in a document. After training ends, the previous parameters are adjusted based on its performance and the process is iterated again.

The third step, the trained deep convolutional network is adjusted into a test mode, all frame images of the video images are input into the deep convolutional network, and an action category of the experimental animal in each frame image is automatically identified through the deep convolutional network.

The fourth step, a fully connected layer of the deep convolutional network is trained using the trajectory data, body temperature data, and neuronal signals in the packaged data, and the action category sequence of the video images is output after correcting the action category of the experimental animal.
S5, a clustering mining module is used to perform clustering on the action category sequence in combination with the trajectory data, the body temperature data, and the neuronal signals, thereby creating behavioral pattern categories. The behavioral pattern categories are then mapped to the time series of the video images, thereby obtaining a behavioral pattern category sequence for the experimental animal.

In this step, the clustering mining module is composed of a synchronization program, a clustering program, and a visualization program. The synchronization program is used to normalize and synchronize the packaged data from the data acquisition card, and output a multi-dimensional array that includes time and various recorded data sequences. The clustering program is adapted from a Toeplitz inverse covariance-based clustering method. Its core lies in deep learning and Markov processes, and it is used to automatically identify closely related action categories of the same type from the multi-dimensional array by using differences in correlations between different-dimensional arrays of different action categories as distinction, thereby generating behavioral pattern categories. Finally, it outputs a time sequence labeled with different behavioral pattern categories. The visualization program is used to display the behavioral pattern category sequence in the form of subtitles overlaid on the time series of the original video images, facilitating researchers in determining whether the behavioral pattern recognition is accurate and adjusting the parameter settings of the clustering program accordingly. It can be understood that the TICC clustering algorithm can also be replaced by other multi-dimensional data clustering algorithms such as K-means.

In particular, the process of the clustering mining module performing clustering on the action category sequence in combination with the trajectory data, the body temperature data, and the neuronal signals specifically includes the following.

The first step, the synchronization program is used to retrieve the packaged data uploaded by the data acquisition card, synchronize all packaged data onto a single timeline based on start and end times, time-stamping signals, and wavelet transform detection of the packaged data, and a multi-dimensional array including multimodal data such as time is output.

The second step, the action categories output by the deep convolutional network are input into the clustering program together with the multi-dimensional array. After setting parameters for the clustering program such as the number of clusters, convergence criteria, interval duration, and so on, the clustering program is executed. It then automatically performs clustering to generate behavioral pattern categories and maps these behavioral pattern categories to the time series of the video images, thereby obtaining a behavioral pattern category sequence.

The third step, the visualization program is used to convert the behavioral pattern category sequence into a subtitle file, and displaying the subtitle file in the original video images. Researchers use the video images along with the subtitle file to judge whether the behavioral pattern recognition is correct. After adjusting the relevant parameters of the clustering program, the process is iterated again until the behavioral pattern categories align with the researchers' empirical judgment. Then the parameters of the clustering program are fixed for subsequent data clustering use.

Based on the above, the animal behavior pattern mining method according to the embodiments of the present application utilize various electronic components to achieve synchronous recording of multimodal data such as video images, infrared temperature, real-time position, and neuronal signals. This enables comprehensive, three-dimensional capture of the behavioral states of experimental animals and avoids the impact of factors such as lighting, noise, and camera shake on the video images. Furthermore, a deep convolutional network is employed to automatically identify the action categories of the experimental animals in each frame of the video images. By combining these action categories with trajectory data, body temperature data, and neuronal signals, the behavioral pattern categories of the experimental animals are predicted. This approach fully leverages the patterns and regularities among different actions within the video images, thereby facilitating improved accuracy in the identification of animal behavior patterns. The present application is conveniently configured, imposes no restrictions on usage time, and can be widely applied to experimental animals of various species and sizes.

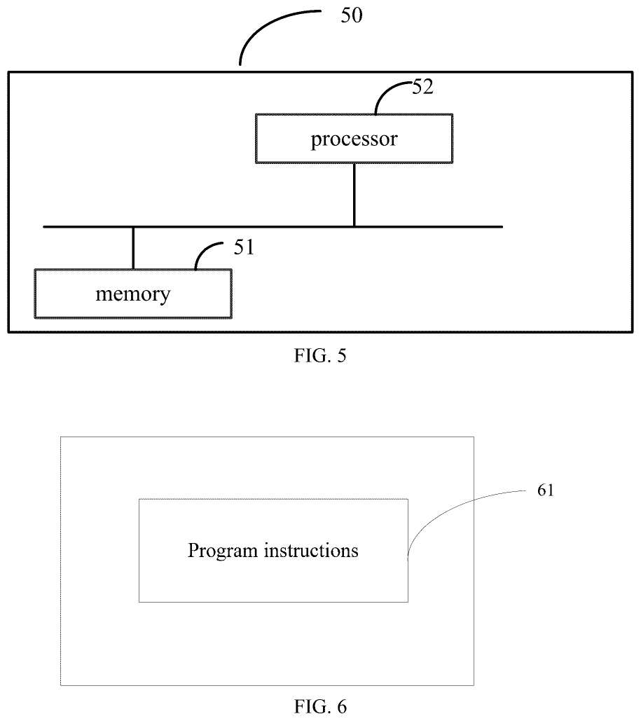

Referring to FIG. 5, which is a structural schematic diagram of a computer device according to an embodiment of the present application. The computer device 50 includes:
a memory 51 storing executable program instructions; and
a processor 52 connected to the memory 51;
wherein the processor 52 is used to retrieve the executable program instructions stored in the memory 51 and execute the following steps: using an infrared touch screen, a camera, a thermal infrared probe, and a brain endoscope to collect trajectory data, video images, body temperature data, and neuronal signals of an experimental animal respectively; uploading the trajectory data, the video images, the body temperature data, and the neuronal signals to a PC device; using the PC device to acquire a behavioral pattern category of the experimental animal by combining the trajectory data, the video images, the body temperature data, and the neuronal signals.

Among them, the processor 52 may also be referred to as a CPU (Central Processing Unit). The processor 52 may be an integrated circuit chip with signal processing capabilities. The processor 52 may also be a general-purpose processor, a digital signal processor (DSP), an application-specific integrated circuit (ASIC), a field-programmable gate array (FPGA), or other programmable logic devices, discrete gate or transistor logic devices, or discrete hardware components. The general-purpose processor may be a microprocessor, or the processor may also be any conventional processor, etc.

Referring to FIG. 6, which is a structural schematic diagram of a storage medium according to an embodiment of the present application. The storage medium according to the embodiment of the present application stores program instructions 61 capable of implementing the following steps: using an infrared touch screen, a camera, a thermal infrared probe, and a brain endoscope to collect trajectory data, video images, body temperature data, and neuronal signals of an experimental animal respectively; uploading the trajectory data, the video images, the body temperature data, and the neuronal signals to a PC device; using the PC device to acquire a behavioral pattern category of the experimental animal by combining the trajectory data, the video images, the body temperature data, and the neuronal signals. Among them, the program instructions 61 may be stored in the aforementioned storage medium in the form of a software product, comprising a number of instructions for causing a device (which may be a personal computer, server, network device, etc.) or a processor to execute all or some of the steps of the methods of the various embodiments of the present application. The aforementioned storage medium includes: USB flash drives, mobile hard drives, read-only memory (ROM), random-access memory (RAM), magnetic disks, optical discs, and various other media capable of storing program instructions, or terminal devices such as computers, servers, mobile phones, and tablets. Here, the server may be a standalone server, and may also be a cloud server providing basic cloud computing services such as cloud services, cloud databases, cloud computing, cloud functions, cloud storage, network services, cloud communications, middleware services, domain name services, security services, content delivery networks (CDN), as well as big data and artificial intelligence platforms.

In these embodiments provided by the present application, it should be understood that the disclosed systems, devices, and methods may be implemented in other manners. For example, the system embodiments described above are merely illustrative; for instance, the division of units is only a logical functional division, and in actual implementation, there may be other division methods. For example, multiple units or components may be combined or integrated into another system, or some features may be omitted or not executed. Additionally, the displayed or discussed mutual couplings, or direct couplings, or communication connections may be indirect couplings or communication connections through some interfaces, devices, or units, and may be electrical, mechanical, or of other forms.

Furthermore, the various functional units in each embodiment of the present application may be integrated into one processing unit, or each unit may also exist separately as a physical entity, or two or more units may also be integrated into one unit. The above-mentioned integrated units may be implemented in the form of hardware, and may also be implemented in the form of software functional units. The foregoing descriptions are merely embodiments of the present application and are not intended to limit the patent scope of the present application. Any equivalent structure or equivalent process transformation made based on the content of the specification and drawings of the present application, or any direct or indirect application in other related technical fields, shall similarly be included within the patent protection scope of the present application.

What is claimed is:

1. An animal behavior pattern mining system, comprising a PC device and an experiment box body; wherein the PC device is located out of the experiment box body;
the experiment box body is further provided therein with an infrared touch screen, a transparent box body, a camera, a thermal infrared probe, and a brain endoscope respectively; the infrared touch screen is arranged at a bottom of the experiment box body, the transparent box body is arranged above the infrared touch screen, the camera and the thermal infrared probe are respectively fixed on the transparent box body, and the infrared touch screen, the camera, the thermal infrared probe, and the brain endoscope are respectively connected to the PC device; the transparent box body is configured to place an experimental animal, the infrared touch screen, the camera, and the thermal infrared probe are respectively configured to acquire trajectory data, video images, and body temperature data of the experimental animal, the brain endoscope is configured to acquire neuron signals of the experimental animal; the PC device is configured to acquire a behavior pattern category of the experimental animal by combining the trajectory data, the video images, the body temperature data, and the neuron signals;
wherein the PC device comprises a deep convolutional network and a clustering mining module, and that the PC device is configured to acquire a behavior pattern category of the experimental animal by combining the trajectory data, the video images, the body temperature data, and the neuron signals is specifically as follows;
using the deep convolutional network to automatically identify an action category of the experimental animal in each frame of the video images, correcting the action category using the trajectory data, the body temperature data, and neuronal signals, and then outputting an action category sequence for the video images;
using the clustering mining module to perform clustering on the action category sequence in combination with the trajectory data, body temperature data, and neuronal signals, and map the clustered action category sequence to time series of the video images, thereby obtaining a behavioral pattern category sequence for the experimental animal.

2. The animal behavior pattern mining system according to claim 1, wherein the experimental box body is a square structure with an aluminum alloy frame; surfaces of six faces of the experimental box body are covered with opaque acrylic panels, and sound-absorbing panels are attached to the inner side of each of the six faces; one side of the experimental box body is a detachable structure configured to place experimental animals therein during experiments.

3. The animal behavior pattern mining system according to claim 2, wherein the experimental box body further comprises a development board, a sound wave generator, and a display therein; the development board is arranged on an inner upper surface of the experimental box body, the sound wave generator and the display are respectively attached to an inner upper part of the experimental box body and are sequentially connected to the development board and the PC device via wires; the PC device is configured to control the development board to generate stimulation signals and thereby cause the sound wave generator and display connected therewith to produce auditory and visual stimuli respectively.

4. The animal behavior pattern mining system according to claim 3, wherein the experimental box body further comprises a data acquisition card therein, the infrared touch screen, the camera, the thermal infrared probe, and the brain endoscope are respectively connected to the data acquisition card, and the data acquisition card is connected to the PC device; the data acquisition card is configured to synchronize and package the trajectory data, video images, body temperature data, and neuronal signals and then transmit packaged data to the PC device.

5. (canceled)

6. The animal behavior pattern mining system according to claim 1, wherein the using the deep convolutional network to automatically identify an action category of the experimental animal in each frame of the video images is specifically as follows:
extracting all frame images from the video images, and randomly selecting a set number of frame images as a dataset requiring manual labeling;
organizing frame images of various categories from the dataset for manual labeling, and inputting the manually labeled training set images into the deep convolutional network for training, wherein ResNet50 is selected as a backbone network for the deep convolutional network;
inputting all frame images of the video images into the trained deep convolutional network, and using the deep convolutional network to automatically identify an action category of the experimental animal in each frame image;
training a fully connected layer of the deep convolutional network using the trajectory data, body temperature data, and neuronal signals, and outputting the action category sequence of the video images after correcting the action category of the experimental animal in each frame image.

7. The animal behavior pattern mining system according to claim 6, wherein the clustering mining module comprises a synchronization program, a clustering program, and a visualization program; the using the clustering mining module to perform clustering on the action category sequence in combination with the trajectory data, body temperature data, and neuronal signals is specifically as follows:
using the synchronization program to retrieve the packaged data and synchronize all packaged data onto a single timeline based on start and end times, time-stamping signals, and wavelet transform detection of the packaged data, and outputting a multi-dimensional array including time;
inputting the action category sequence and the multi-dimensional array into the clustering program for automatic clustering; wherein the clustering program uses differences in correlations between different-dimensional arrays of different action categories as distinction, identifies closely related action categories of the same type from the multi-dimensional array to generate behavioral pattern categories, and maps the behavioral pattern categories to the time series of the video images, thereby obtaining a behavioral pattern category sequence;
using the visualization program to convert the behavioral pattern category sequence into a subtitle file, and displaying the subtitle file in the video images.

8-10. (canceled)
